(19) United States
(12) Patent Application Publication
(10) Pub. No.: US 2012/0098739 A1
(43) Pub. Date: Apr. 26, 2012

(54) SPLICED ELECTROPHORETIC DISPLAY PANEL

(75) Inventors: Ming-Che Hsieh, Taipei City (TW); Shih-Hsing Hung, Hsinchu County (TW); Chih-Jen Hu, Hsinchu City (TW)

(73) Assignee: AU OPTRONICS CORPORATION, Hsinchu (TW)

(21) Appl. No.: 13/046,705

(22) Filed: Mar. 12, 2011

(30) Foreign Application Priority Data
Oct. 22, 2010 (TW) 99136138

(51) Int. Cl. G09G 3/34

(52) U.S. Cl. 345/107

(57) ABSTRACT

A spliced electrophoretic display panel includes a plurality of electrophoretic display units arranged in an array and connected to one another. Each of the electrophoretic display units includes a first substrate, a second substrate, an electrophoretic display layer, and a sealant. The second substrate is configured under the first substrate. At least one edge of the first substrate goes beyond an edge of the second substrate. The electrophoretic display layer is configured between the first substrate and the second substrate. An image displayed by the electrophoretic display layer is observed via the first substrate. The sealant is connected to the electrophoretic display layer, the first substrate, and the second substrate. Besides, the sealant surrounds the electrophoretic display layer. The first substrate of each of the electrophoretic display units is connected to the adjacent first substrate.

### CROSS-REFERENCE TO RELATED APPLICATION

This application claims the priority benefit of Taiwan application serial no. 99136138, filed Oct. 22, 2010. The entirety of the above-mentioned patent application is hereby incorporated by reference herein and made a part of this specification.

### BACKGROUND OF THE INVENTION

1. Field of the Invention

The invention relates to a display panel, and in particular to an electrophoretic display panel.

2. Description of Related Art

With vigorous development of flat panel display technologies, a user not only requires favorable performance of the display panel but also expects pleasant exterior of the display panel from an aesthetic perspective. To comply with said requirement, most manufacturers of display panels have begun to develop flat display panels with slim borders.

Common flat display panels include liquid crystal display (LCD) panels, plasma display panels, electrophoretic display panels, and so on. FIG. 1 is a schematic cross-sectional view exemplarily showing an electrophoretic display panel. With reference to FIG. 1, a conventional electrophoretic display panel 100 (100′) includes a first substrate 110, a second substrate 120, an electrophoretic display layer 130 located between the first substrate 110 and the second substrate 120, and a sealant 140 (140′) surrounding the electrophoretic display layer 130. The electrophoretic display panel 100 (100′) has a display region R and a non-display region R′. The non-display region R′ is the so-called border region. In FIG. 1, the non-display region R′ of the upper electrophoretic display panel 100 has a relatively large width W_{B}, while the non-display region R′ of the lower electrophoretic display panel 100′ has a relatively small width W_{B}′.

When the width W_{B} is reduced to the width W_{B}′, the electrophoretic display panel 100′ with the slim border design can be formed, whereas a width Wₛ of the sealant 140 in the electrophoretic display panel 100 is required to be reduced to a relatively small width Wₛ′. As such, in comparison with the sealant 140 having the relatively large width Wₛ′, the sealant 140′ with the small width Wₛ′ in the electrophoretic display panel 100′ prevents less moisture from entering the electrophoretic display layer 130.

In addition, the area of the second substrate 120 in the conventional electrophoretic display panel 100′ with the slim border design is greater than the area of the first substrate 110, and an edge 120a of the second substrate 120 goes beyond an edge 110a of the first substrate 110. Therefore, when the second substrate 120 of the electrophoretic display panel 100′ with the slim border design is connected to the second substrate 120 of another electrophoretic display panel 100′ with the slim border design, a spliced electrophoretic display panel with large area is formed, and a gap exists between the first substrate 110 and the adjacent first substrate 110 in the spliced electrophoretic display panel.

Since images displayed by the electrophoretic display layer 130 are observed via the first substrate 110 of the spliced electrophoretic display panel, the gap is very much likely to be found. Namely, the untidy splices in the spliced electrophoretic display panel can be easily observed, which negatively affects the user's visual perception of the appearance of electrophoretic display panel. Accordingly, how to block the user from perceiving the untidy splices in the spliced electrophoretic display panel becomes an important issue to be solved immediately.

### SUMMARY OF THE INVENTION

The invention is directed to a spliced electrophoretic display panel in which an area of a first substrate in an electrophoretic display unit is greater than an area of a second substrate in the electrophoretic display unit, and an edge of the first substrate goes beyond an edge of the second substrate. Thereby, the first substrate in the electrophoretic display unit can be closely connected to the adjacent first substrate(s). As such, a user is rather unlikely to perceive the untidy splice between adjacent electrophoretic display units when the user views a display image via the first substrate.

The invention provides a spliced electrophoretic display panel that includes a plurality of electrophoretic display units arranged in an array and connected to one another. Each of the electrophoretic display units includes a first substrate, a second substrate, an electrophoretic display layer, and a sealant. The second substrate is configured under the first substrate. At least one edge of the first substrate goes beyond an edge of the second substrate. The electrophoretic display layer is configured between the first substrate and the second substrate. An image displayed by the electrophoretic display layer is observed via the first substrate. The sealant is connected to the electrophoretic display layer, the first substrate, and the second substrate. Besides, the sealant surrounds the electrophoretic display layer. The first substrate of each of the electrophoretic display units is physically connected to the adjacent first substrate.

According to an embodiment of the invention, a gap is between the second substrate of each of the electrophoretic display units and the adjacent second substrate or the adjacent second substrates.

According to an embodiment of the invention, the edge of the second substrate goes beyond an edge of the electrophoretic display layer. The sealant is distributed between the first substrate and the second substrate, and an outer edge of the sealant is substantially aligned to the edge of the second substrate.

According to an embodiment of the invention, the edge of the second substrate goes beyond an edge of the electrophoretic display layer. A portion of the sealant is distributed between the first substrate and the second substrate, and the other portion of the sealant is connected to a sidewall of the second substrate. An outer edge of the sealant goes beyond the edge of the second substrate.

According to an embodiment of the invention, the outer edge of the sealant is substantially aligned to the edge of the first substrate.

According to an embodiment of the invention, the maximum height of the sealant is substantially equal to the total thickness of the second substrate and the electrophoretic display layer.

According to an embodiment of the invention, an edge of the electrophoretic display layer is substantially aligned to the edge of the second substrate, the sealant is connected to a sidewall of the second substrate, and the sealant further covers a portion of an outer surface of the second substrate.

According to an embodiment of the invention, the outer edge of the sealant is substantially aligned to the edge of the first substrate.

According to an embodiment of the invention, the maximum height of the sealant is greater than the total thickness of the second substrate and the electrophoretic display layer.

According to an embodiment of the invention, the spliced electrophoretic display panel can further include a passivation layer that covers outer surfaces of the second substrates.

According to an embodiment of the invention, an area of the first substrate is greater than an area of the second substrate.

Based on the above, the area of the first substrate in the spliced electrophoretic display panel is greater than the area of the second substrate, for example, and an edge of the first substrate goes beyond an edge of the second substrate. Hence, the first substrate can be closely connected to the adjacent first substrate(s). As such, a user is rather unlikely to perceive the untidy splices in the spliced electrophoretic display panel when the user views the display image via the first substrate.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view illustrating a conventional electrophoretic display panel.

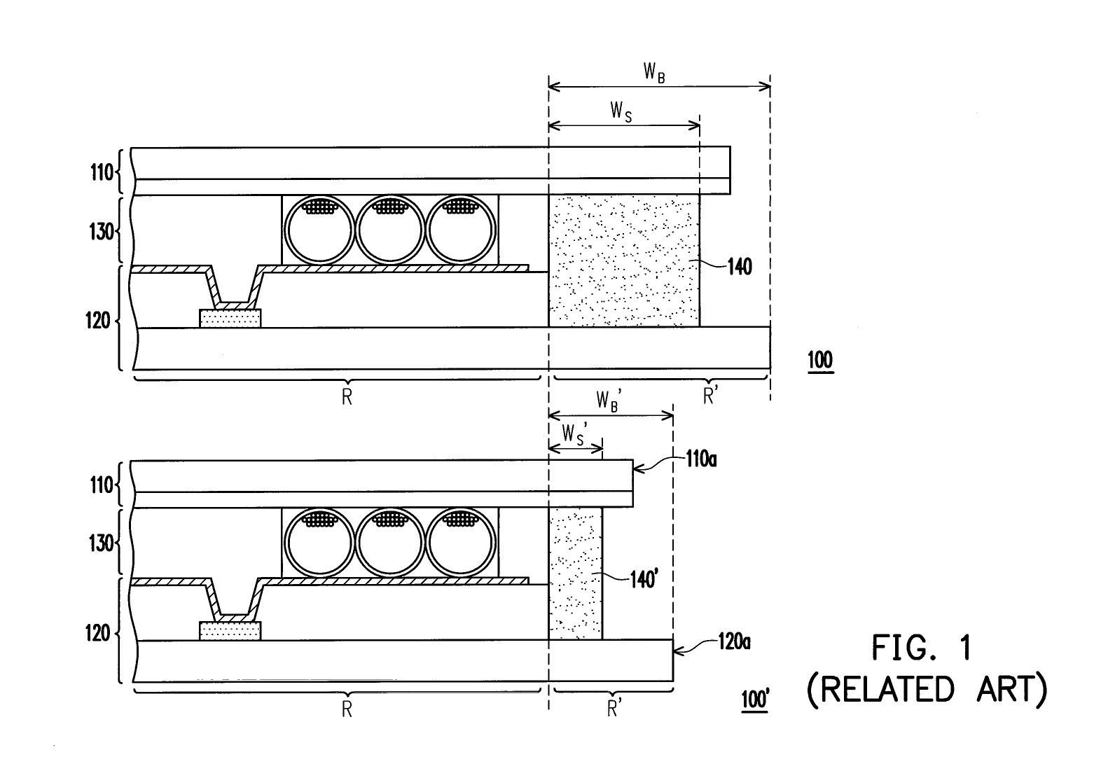

FIG. 2 is a schematic cross-sectional view illustrating an electrophoretic display unit according to a first embodiment of the invention.

FIG. 3 is a schematic cross-sectional view illustrating a spliced electrophoretic display panel according to the first embodiment of the invention.

FIG. 4 is a schematic cross-sectional view illustrating a spliced electrophoretic display panel according to a second embodiment of the invention.

FIG. 5 is a schematic cross-sectional view illustrating a spliced electrophoretic display panel according to a third embodiment of the invention.

### DESCRIPTION OF EMBODIMENTS

### First Embodiment

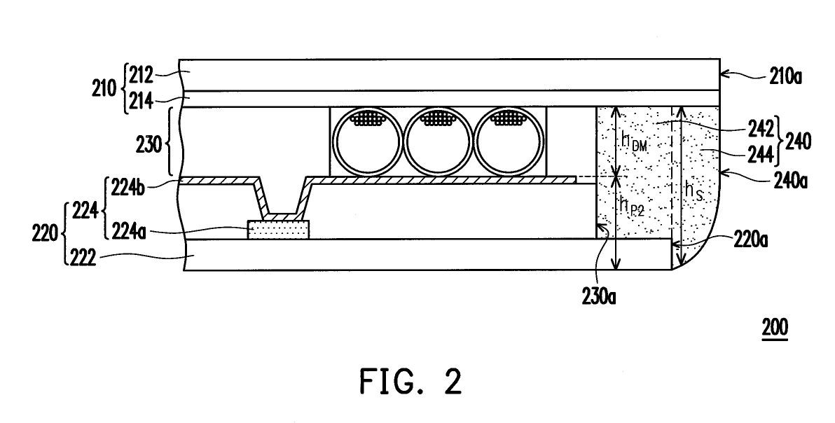

FIG. 2 is a schematic cross-sectional view illustrating an electrophoretic display unit according to a first embodiment of the invention. With reference to FIG. 2, the electrophoretic display unit 200 of this embodiment includes a first substrate 210, a second substrate 220, an electrophoretic display layer 230, and a sealant 240. The second substrate 220 is configured under the first substrate 210. The electrophoretic display layer 230 is configured between the first substrate 210 and the second substrate 220. The sealant 240 is connected to the electrophoretic display layer 230, the first substrate 210, and the second substrate 220. Besides, the sealant 240 surrounds the electrophoretic display layer 230.

In this embodiment, the first substrate 210 may include a first base 212 and a common electrode 214 that covers the first base 212. The first base 212 of this embodiment is, for example, a transparent base and can be made of glass, quartz, plastic, or other appropriate materials. The common electrode 214 of this embodiment is, for instance, a transparent conductive layer and can be made of indium tin oxide (ITO), indium zinc oxide (IZO), or other appropriate conductive materials.

The second substrate 220 of this embodiment can include a second base 222 and an active device array layer 224 formed over the second base 222. In this embodiment, the second base 222 can be made of glass, quartz, plastic, an opaque/reflective material (such as a conductive material, wafer, ceramics, or the like), or other suitable materials. The active device array layer 224 of this embodiment includes active devices 224a and pixel electrodes 224b, for instance. In this embodiment, the active devices 224a are bottom-gate thin film transistors, which should however not be construed as a limitation to this invention. According to other embodiments of the invention, the active devices 224a can also be top-gate thin film transistors. The pixel electrodes 224b of this embodiment are reflective conductive electrodes, for instance. The reflective conductive electrodes not only can serve as the pixel electrode but also can reflect the light that enters the first substrate 210. As such, the issue of photo-leakage current is less likely to arise in the active devices 224a. However, materials of the pixel electrodes 224b of the invention are not limited thereto. In other embodiments of the invention, the pixel electrodes 224b can be a transparent conductive layers, and the active device array layer 224 can further include another reflective layer that reflects the light entering the first substrate 210.

In this embodiment, an edge 230a of the electrophoretic display layer 230 does not go beyond an edge 220a of the second substrate 220, as shown in FIG. 2. The electrophoretic display layer 230 of this embodiment is a thin film type electrophoretic display layer, for instance.

In this embodiment, the maximum height h_{S} of the sealant 240 is substantially equal to the total of the thickness h_{P2} of the second substrate 220 and the thickness h_{DM} of the electrophoretic display layer 230. Additionally, an outer edge 240a of the sealant 240 is substantially aligned to the edge 210a of the first substrate 210a. The sealant 240 of this embodiment can be made of a thermal curable sealing material, a photo-curable sealing material, a hybrid sealing material, or other appropriate sealing materials.

In each of the electrophoretic display units 200 of this embodiment, note that the area of the first substrate 210 is greater than the area of the second substrate 220, for example, and the edge 210a of the first substrate 210 goes beyond the edge 220a of the second substrate 220. Hence, a portion 242 of the sealant 240 is distributed between the first substrate 210 and the second substrate 220, and the other portion 244 of the sealant 240 is located under the first substrate 210. Here, the portion 244 of the sealant 240 is connected to a sidewall of the second substrate 220. Namely, the outer edge 240a of the sealant 240 goes beyond the edge 220a of the second substrate 220. In this embodiment, the two portions 242 and 244 of the sealant 240 can be made of the same material or different materials.

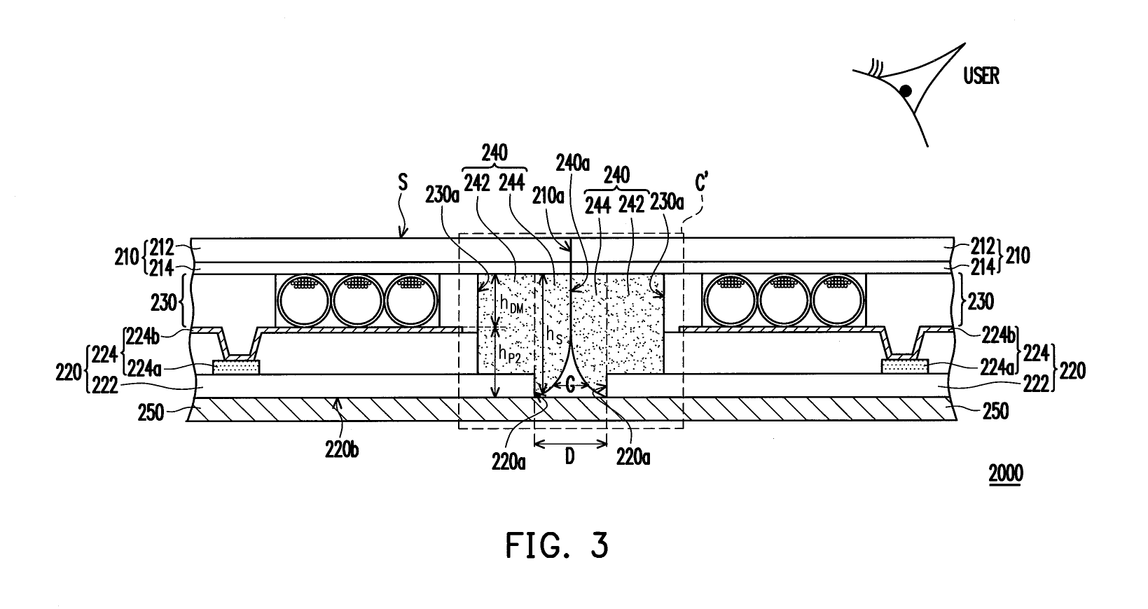

FIG. 3 is a schematic cross-sectional view illustrating a spliced electrophoretic display panel according to this embodiment of the invention. With reference to FIG. 3, the spliced electrophoretic display panel 2000 of this embodiment is constituted by a plurality of electrophoretic display units arranged in an array and connected to one another.

In the spliced electrophoretic display panel 2000 of this embodiment, the first substrate 210 of each of the electrophoretic display units is physically connected to the adjacent first substrate 210 or the adjacent first substrates 210. According to this embodiment, note that the area of the first substrate 210 is greater than the area of the second substrate 220, the edge 210a of the first substrate 210 goes beyond the edge 220a of the second substrate 220, and the outer edge 240a of the sealant 240 is substantially aligned to the edge 210a of the first substrate 210. Therefore, the first substrate 210 of each of the electrophoretic display units can be closely connected to the adjacent first substrate 210 or the adjacent first substrates 210. Additionally, in the spliced electrophoretic display panel 2000 of this embodiment, a gap D is between each of the second substrates 220 and the adjacent second substrate 220 or the adjacent second substrates 220, and a gap G is between the outer edge 240a of the sealant 240 and the outer edge 240a of the adjacent sealant 240 close to the second substrate 220.

In this embodiment, an image displayed by the electrophoretic display layer 230 is observed via the first substrate 210. That is to say, a plane formed by splicing each of the first substrates 210 is the display surface S of the spliced electrophoretic display panel 2000 of this embodiment.

The adjacent first substrates 210 are closely connected to one another in this embodiment. Accordingly, a user is rather unlikely to perceive the gap G located below the display surface S when the user views the display image via the display surface S. To be more specific, according to this embodiment, when the user views the image on the spliced electrophoretic display panel 2000, the user is not apt to perceive the untidy splice C′ between each of the electrophoretic display units, so as to provide the user with satisfactory visual perception of the exterior of the spliced electrophoretic display panel 2000.

On the other hand, the spliced electrophoretic display panel 2000 of this embodiment can further include a passivation layer 250. According to this embodiment, the passivation layer 250 covers an outer surface 220b of each of the second substrates 220. The passivation layer 250 of this embodiment gives enhanced improvement of the reliability of the spliced electrophoretic display panel 2000. Particularly, the passivation layer 250 of this embodiment further prevents the moisture from entering the electrophoretic display layer 230 and reduces the probability of deteriorating the electrophoretic display layer 230.

### Second Embodiment

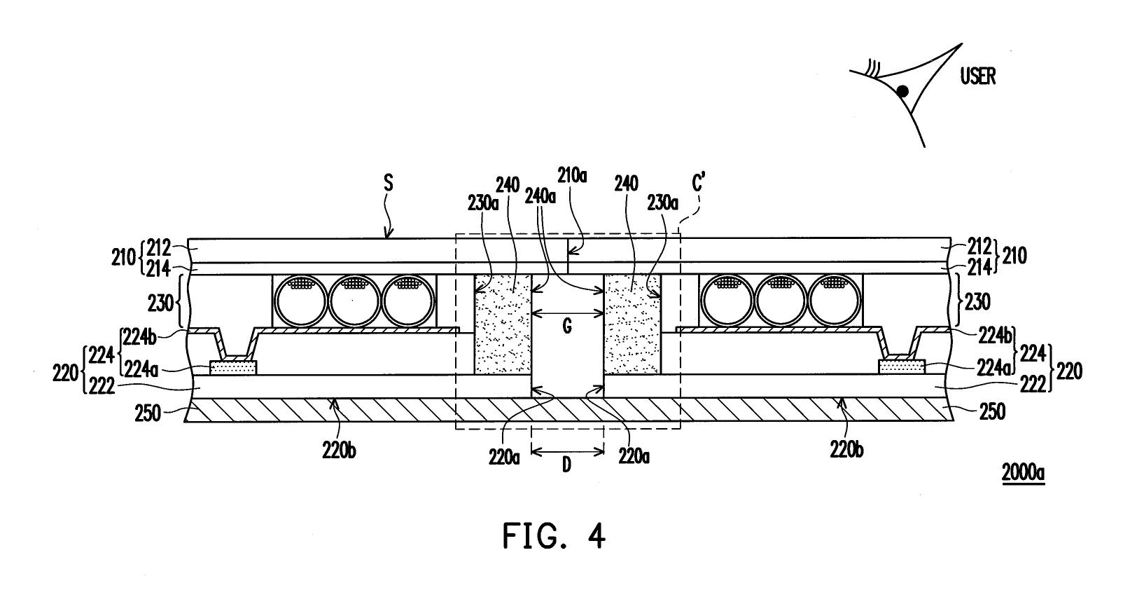

FIG. 4 is a schematic cross-sectional view illustrating a spliced electrophoretic display panel according to a second embodiment of the invention. With reference to FIG. 4, the spliced electrophoretic display panel 2000a of this embodiment has the structure similar to that of the spliced electrophoretic display panel 2000 described in the first embodiment, and the main difference therebetween lies in that the outer edge 240a of the sealant 240 is substantially aligned to the edge 220a of the second substrate 220 in this embodiment.

In the spliced electrophoretic display panel 2000a of this embodiment, the area of the first substrate 210 is greater than the area of the second substrate 220, the edge 210a of the first substrate 210 goes beyond the edge 220a of the second substrate 220, and the outer edge 240a of the sealant 240 does not go beyond the edge 210a of the first substrate 210. Hence, in this embodiment, each of the first substrates 210 is closely connected to the adjacent first substrate(s) 210.

As such, a user is rather unlikely to perceive the gap G located below the first substrate 210 when the user views the display image via the display surface S formed by splicing each of the first substrates 210. That is to say, the user is not apt to perceive the untidy splice C′ between each of the electrophoretic display units in the spliced electrophoretic display panel 2000a of this embodiment.

### Third Embodiment

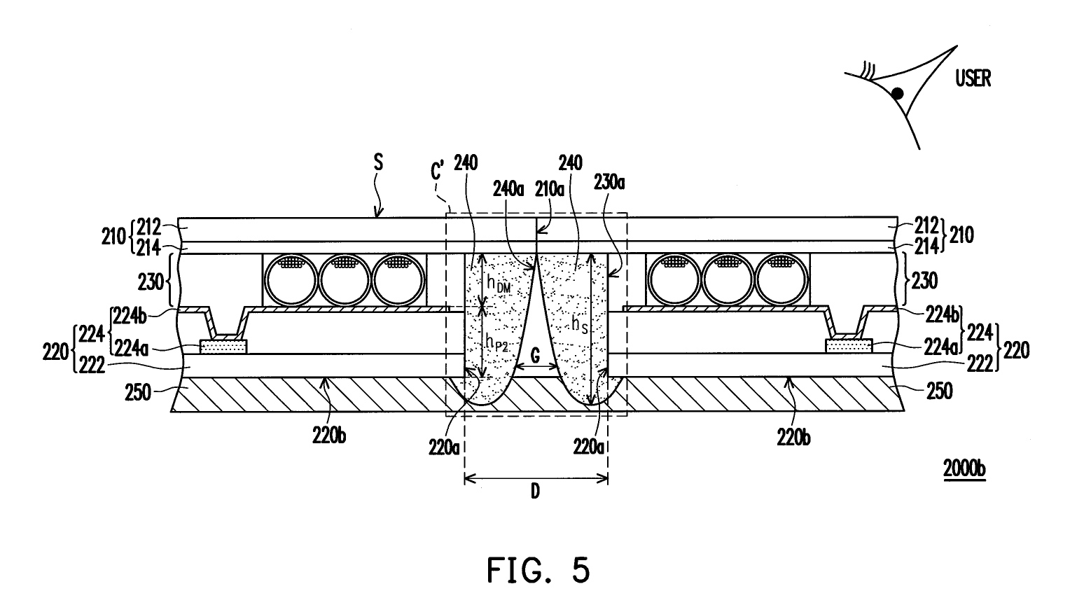

FIG. 5 is a schematic cross-sectional view illustrating a spliced electrophoretic display panel according to a third embodiment of the invention. With reference to FIG. 5, the spliced electrophoretic display panel 2000b of this embodiment has the structure similar to that of the spliced electrophoretic display panel 2000 described in the first embodiment. The main difference therebetween lies in that the edge 230a of the electrophoretic display layer 230 is substantially aligned to the edge 220a of the second substrate 220 in this embodiment, the sealant 240 of this embodiment is connected to a sidewall of the second substrate 220, and the sealant 240 further covers a portion of the outer surface 220b of the second substrate 220. In this embodiment, the maximum height h_{S} of the sealant 240 is greater than the total of the thickness h_{P2} of the second substrate 220 and the thickness h_{DM} of the electrophoretic display layer 230.

In this embodiment, the outer edge 240a of the sealant 240 is substantially aligned to the edge 210a of the first substrate 210 as well. Each of the first substrates 210 is also closely connected to the adjacent first substrate(s) 210. That is to say, the user is not apt to perceive the untidy splice C′ between each of the electrophoretic display units in the spliced electrophoretic display panel 2000b of this embodiment.

To sum up, in the spliced electrophoretic display panel of this invention, the edge of the first substrate goes beyond the edge of the second substrate, while the outer edge of the sealant does not go beyond the edge of the first substrate. Thereby, each of the first substrates can be closely connected to the adjacent first substrate(s). As such, a user is rather unlikely to perceive the gap located below the first substrate when the user views the display image via the display surface S formed by splicing each of the first substrates. Namely, the user is not apt to perceive the untidy splice between each of the electrophoretic display units, which provides the user with satisfactory visual perception of the exterior of the spliced electrophoretic display panel from an aesthetic perspective.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A spliced electrophoretic display panel comprising:
a plurality of electrophoretic display units arranged in an array and connected to one another, each of the electrophoretic display units comprising:
a first substrate;
a second substrate configured under the first substrate, at least one edge of the first substrate going beyond an edge of the second substrate;
an electrophoretic display layer configured between the first substrate and the second substrate, wherein an image displayed by the electrophoretic display layer is observed via the first substrate; and
a sealant bonded to the first substrate and the second substrate, the sealant surrounding the electrophoretic display layer, wherein the first substrate of each of the electrophoretic display units is connected to the adjacent first substrate.

2. The spliced electrophoretic display panel as claimed in claim 1, wherein a gap is between the second substrate of each of the electrophoretic display units and the adjacent second substrate.

3. The spliced electrophoretic display panel as claimed in claim 1, wherein the edge of the second substrate goes beyond an edge of the electrophoretic display layer, the sealant is distributed between the first substrate and the second substrate, and an outer edge of the sealant is substantially aligned to the edge of the second substrate.

4. The spliced electrophoretic display panel as claimed in claim 1, wherein the edge of the second substrate goes beyond an edge of the electrophoretic display layer, a portion of the sealant is distributed between the first substrate and the second substrate, the sealant is connected to a sidewall of the second substrate, and an outer edge of the sealant goes beyond the edge of the second substrate.

5. The spliced electrophoretic display panel as claimed in claim 4, wherein the outer edge of the sealant is substantially aligned to the edge of the first substrate.

6. The spliced electrophoretic display panel as claimed in claim 4, wherein a maximum height of the sealant is substantially equal to a total thickness of the second substrate and the electrophoretic display layer.

7. The spliced electrophoretic display panel as claimed in claim 1, wherein an edge of the electrophoretic display layer is substantially aligned to the edge of the second substrate, the sealant is connected to a sidewall of the second substrate, and the sealant further covers a portion of an outer surface of the second substrate.

8. The spliced electrophoretic display panel as claimed in claim 7, wherein an outer edge of the sealant is substantially aligned to the edge of the first substrate.

9. The spliced electrophoretic display panel as claimed in claim 7, wherein a maximum height of the sealant is greater than a total thickness of the second substrate and the electrophoretic display layer.

10. The spliced electrophoretic display panel as claimed in claim 1, further comprising a passivation layer covering outer surfaces of the second substrates.

11. The spliced electrophoretic display panel as claimed in claim 1, wherein an area of the first substrate is greater than an area of the second substrate.

12. The spliced electrophoretic display panel as claimed in claim 1, wherein the first substrate of each of the electrophoretic display units is physically connected to the adjacent first substrate.
